(19) United States
(12) Patent Application Publication
(10) Pub. No.: US 2017/0334233 A1
(43) Pub. Date: Nov. 23, 2017

(54) ANIMATED SECURITY DEVICE FOR A DOCUMENT

(71) Applicant: Innovia Security Pty Ltd, Craigieburn, Victoria (AU)

(72) Inventor: Michael Harwick, Craigieburn, Victoria (AU)

(73) Assignee: Innovia Security Pty Ltd, Craigieburn, Victoria (AU)

(21) Appl. No.: 15/525,767

(22) PCT Filed: Nov. 13, 2015
(86) PCT No.: PCT/AU2015/050711

§ 371 Date: May 10, 2017

(30) Foreign Application Priority Data
Nov. 14, 2014 (AU) 2014101368
Nov. 14, 2014 (AU) 2014904585

(51) Int. Cl. B42D 25/328; G02B 27/42; B42D 25/425; B42D 25/378; B42D 25/29; G03B 25/00; B42D 25/351; B42D 25/23; B42D 25/26; B42D 25/25; B42D 25/24

(52) U.S. Cl. CPC B42D 25/328; G03B 25/00; G02B 27/4205; B42D 25/425; B42D 25/378; B42D 25/351; B42D 25/29; B42D 25/26; B42D 25/25; B42D 25/24; B42D 25/23

(57) ABSTRACT

Optical device, and preferably a security device for a security document, and methods for the production thereof, the device including a diffractive optical element (DOE) including a plurality of subregions, wherein each subregion is configured to produce a projected image corresponding to a frame of an animation, wherein the animation includes both a static component and a variable component, and wherein the sub-regions are arranged such that when the DOE is illuminated by a point light source and moved in at least one direction, the animation is viewable as a projected image.

### FIELD OF THE INVENTION

The invention relates to optical devices for documents, for example security devices for use with security documents such as banknotes, and in particular to security devices including diffractive optical elements.

### BACKGROUND TO THE INVENTION

Banknotes (and other security documents) include visual security features that are difficult to reproduce (and, therefore, counterfeit) using conventional means (for example, photocopiers). It is common for such visual security features to display an optical effect such that the visual security features take on a different appearance when viewed from different positions (an optically variable effect). When a counterfeit copy of the security document is made, it is difficult for the counterfeiters to reproduce the effect, and, therefore, it is difficult for a passable copy of the security document to be produced.

However, as the sophistication of counterfeiters increases, the ability to reproduce or mimic complicated security features increases. Therefore, it is possible to produce a counterfeit security document including a passable, if not identical, copy of the visual security features incorporated into the security document.

In the example of banknotes, often members of the public lack the requisite sophistication and/or time to adequately inspect the security features of the banknotes to ensure that the banknotes are legitimate and not counterfeit. This makes it easier for counterfeiters to produce passable counterfeit versions of the banknotes with visual effects close enough to the visual security features of authentic banknotes to dupe, or at least confuse, members of the public.

### SUMMARY OF THE INVENTION

According to a first aspect of the present invention, there is provided an optical device, preferably a security device for a security document, including a diffractive optical element (DOE) including a plurality of subregions, wherein each subregion is configured to produce a projected image corresponding to a frame of an animation, wherein the animation includes both a static component and a variable component, and wherein the sub-regions are arranged such that when the DOE is illuminated by a point light source and moved in at least one direction, the animation is viewable as a projected image.

Advantageously, the provision of both a static component and a variable component to the animation is that the effect of apparent depth can be incorporated into the DOE. This improves on known DOE effects by providing a more visually compelling effect, which may encourage users (such as the general public) to utilise the security benefit provided by the DOE. For example, a more interesting DOE such as provided by the present invention can encourage unsophisticated users to become familiar with the DOE effect.

Another advantageous effect of the inventive DOE is that an improved depth effect can be achieved for the projected image, when the static component of the projected image is itself configured to provide an appearance of depth.

The depth effect or improved depth effect may be provided through the appearance of a parallax effect (pseudo parallax). For example, where the background moves against a static foreground, the foreground may appear to be above the moving background.

Yet another advantageous effect is that the inventive DOE may be more difficult to counterfeit on account of the requirement to provide a more complex projected image.

Preferably, the plurality of subregions are arranged such that when the DOE is moved in at least one direction, the animation is viewable.

The arrangement of sub-regions may be such that the animation is viewable when the DOE is moved in either of two orthogonal directions. The animation may appear the same when the DOE is moved in either of the orthogonal directions. Alternatively, the animation may appear different when the DOE is moved in each of the orthogonal directions.

The animation may alternatively be viewable when the DOE is moved in a first direction, and not viewable when the DOE is moved in a second direction orthogonal to the first direction.

Preferably, at least one of the orthogonal directions is parallel to an edge of the DOE.

In an embodiment, the plurality of subregions are arranged into a plurality of subregion groups. At least one of the subregion groups may be repeated a plurality of times in at least one direction. Alternatively, at least one of the subregion groups may be repeated a plurality of times in a first direction and a plurality of times in a second direction, wherein the first direction is orthogonal to the second direction. Each edge of each subregion group may be adjacent either an edge of another subregion group or an edge of the DOE.

Optionally, the variable component is configured to correspond to a background of the animation, and the static component is configured to correspond to a foreground image of the animation. According to another option, the variable component is configured to correspond to a foreground of the animation, and the static component is configured to correspond to a background image of the animation.

Preferably, each subregion is configured to project a DOE image in substantially the same direction.

In an embodiment, the optical device includes a substrate, wherein the DOE is formed from a radiation curable ink applied to the surface of the substrate, and wherein the DOE is formed by embossing the radiation curable ink and simultaneously or subsequently curing the radiation curable ink.

The DOE may be configured for viewing in one of a reflection mode or a transmission mode.

According to a second aspect of the present invention, there is provided an optical device, preferably a security device for a security document, including a diffractive optical element (DOE) including a plurality of subregions, wherein each subregion is configured to produce a projected image corresponding to a frame of an animation, and wherein the sub-regions are arranged such that when the DOE is illuminated by a point light source and moved in at least one direction, the animation is viewable as a projected image, wherein the animation includes both a static component and a variable component.

According to a third aspect of the present invention, there is provided a method for determining the configuration of the diffractive optical element of the optical device according to either of the first two aspects, including the steps of: determining the static component of the animation; determining the variable component of the animation; determining the required configuration of each subregion based on the static component and the variable component for the required frame of the animation; and determining the required arrangement of the subregions based on the required appearance of the animation.

According to a fourth aspect of the present invention, there is provided a method for producing an optical device according to either of the first two aspects, including the steps of: determining the required configuration of a plurality of subregions of a DOE structure, each subregion being configured to produce a projected image corresponding to a frame of a required animation; determining the arrangement of the plurality of subregions required to produce the animation; providing a substrate; and embossing onto a surface of the substrate a DOE structure with the required configuration and arrangement of subregions.

Preferably, the configuration of each subregion of the DOE structure includes a static component and a variable component for the animation.

According to a fifth aspect of the present invention, there is provided a security document, preferably a banknote, including an optical device according to either of the first aspects.

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that LT<L0, where L0 is the amount of light incident on the document, and LT is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Diffractive Optical Elements (DOEs)

As used herein, the term diffractive optical element refers to a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

### Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

The transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

### BRIEF DESCRIPTION OF THE DRAWINGS

Embodiments of the invention will now be described with reference to the accompanying drawings. It is to be appreciated that the embodiments are given by way of illustration only and the invention is not limited by this illustration. In the drawings:

FIG. 1a shows a document including an optical device;

FIG. 1b shows a substrate having two opacifying layers and an optical device located in a window region

FIG. 1c shows a substrate having two opacifying layers and an optical device located in a half-window region;

FIG. 2 shows a substrate including an embossing layer;

FIG. 3 shows a grid of subregions;

FIG. 4a shows a subregion group including six unique subregions;

FIG. 4b shows a portion of a DOE including repetition of a subregion group;

FIG. 5 shows an alternative subregion group including six unique subregions;

FIG. 6 shows the projected image produced by one of the subregions according to FIGS. 4a, 4b, and 5;

FIG. 7 shows the animation of projected images produced by the plurality of subregions of a subregion group according FIGS. 4a, 4b, and 5;

FIG. 8 shows another subregion group, including sixteen unique subregions; and

FIG. 9 shows animation of projected images produced by the plurality of subregions of the subregion group according to FIG. 7.

### DESCRIPTION OF PREFERRED EMBODIMENT

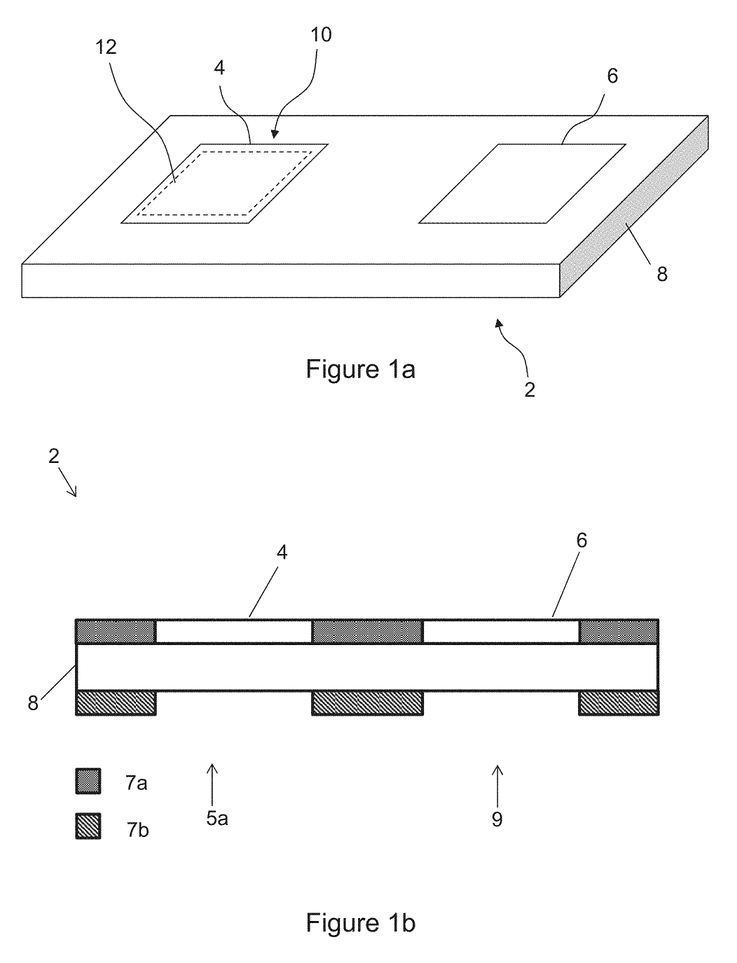

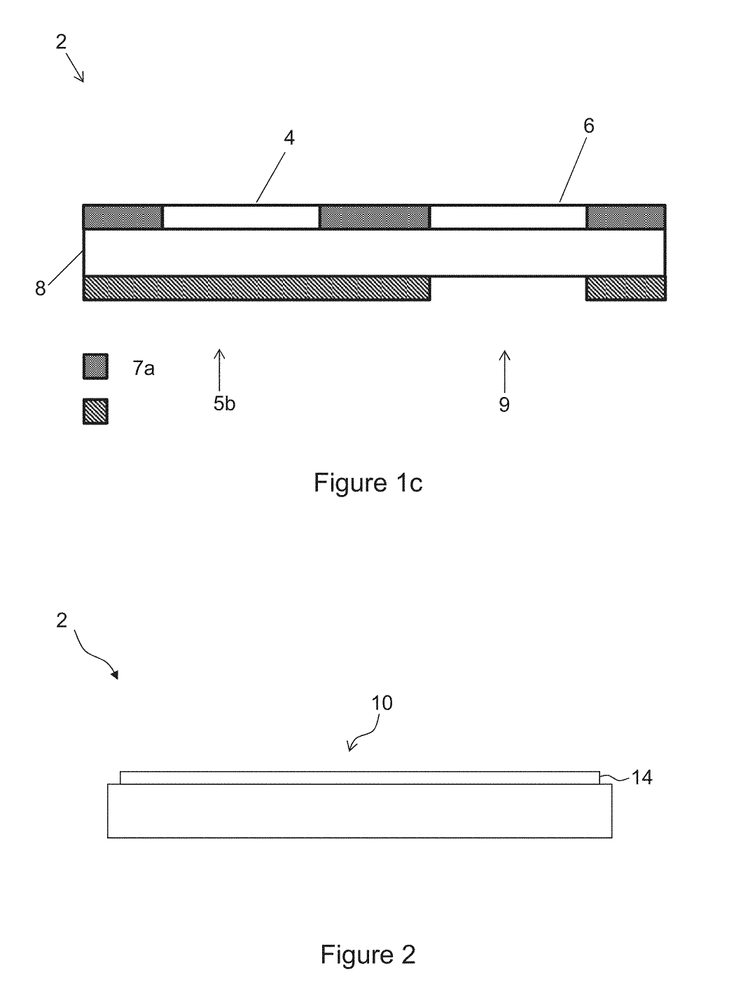

Referring to FIG. 1a, there is provided a document 2 including an optical device 4. According to the embodiments described herein, the optical device 4 is a security device and the document 2 is a security document (such as a banknote, credit card, passport, government document, or any other document requiring a level of security). The document 2 optionally includes one or more additional security features 6. The additional security features 6 can, for example, be selected from: micromirror security devices, holographic security devices, and other optically variable devices.

The document 2 includes a substrate 8. The optical device 4 typically will include a substrate onto which features of the device 4 are formed. In the embodiments described herein, this substrate is the same as the substrate 8 of the document 2. In other embodiments, the optical device 4 is formed separately to the document 2 and subsequently applied to the document 2. In this case, the substrate of the optical device 4 will be different to the substrate 8 of the document 2.

Referring to FIGS. 1b and 1c, there is shown the substrate 8 with first and second opacifying layers 7a, 7b applied to opposing surfaces. In the embodiment of FIG. 1b, the optical device 4 is located in a full window region 5a of the document 2, where both the first and second opacifying layers 7a, 7b are absent in the region of the optical device 4. The embodiment shown in FIG. 1c has the optical device 4 located in a half-window region 5b of the document 2, where the first opacifying layer 7a is absent in the region of the optical device 4 and the second opacifying layer 7b covers the optical device 4. Another embodiment (not shown) combines a window region 5a and a half-window region 5b, such that a portion of the optical device 4 is located in the full window region 5a, and the portion is located in a half-window region 5b. Though the opacifying layers 7a, 7b are shown contiguous with the optical device 4, this is not necessary. For example, there may be a gap between the edge of the optical device 4 and the edge of the opacifying regions 7a, 7b. In each figure the optional security feature 6 is shown in a window region 9.

Referring to FIG. 2, the optical device 4 includes a diffractive optical element (DOE) 10. In the embodiments described herein, the DOE 10 is formed by embossing an embossable layer 14 applied to the substrate 8. In particular, the embossable layer 14 corresponds to a radiation curable ink applied to a surface of the substrate 8. The DOE 10 can be a reflective DOE 10 or a transmission DOE 10. Methods for producing DOEs using radiation curable ink are described in WO 2008/031170 A1, the contents of which are incorporated herein by reference.

A reflective DOE 10 requires the embossable layer 14 to be reflective, which may be an intrinsic property of the embossable layer 14 (such as when the embossable layer 14 includes a metallic ink) or may be provided by a reflective layer applied to the embossable layer 14, preferably after the embossable layer 14 has been embossed. The reflective DOE 10 can be formed within a half-window or full window region of the security document 2.

A transmission DOE 10 requires the substrate 8 and the embossable layer 14 to be transparent. A transmission DOE 10 is located within a window region of the security document 2.

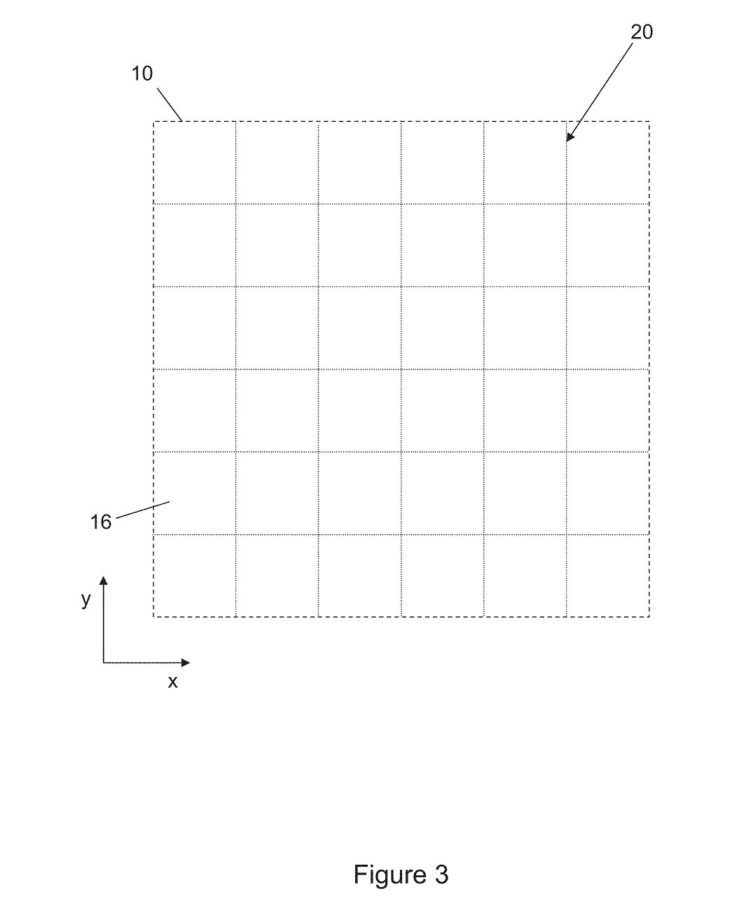

The DOE 10 includes a plurality of subregions 16, wherein each subregion 16 effectively operates as an individual DOE. The subregions 16 can be arranged in a 2-dimensional grid as shown in FIG. 3 (the grid shown in the figure is not intended to necessarily correspond to the entire DOE 10). It should be noted that the arrangement of subregions 16 is not limited to a regular grid of adjacent subregions 16, for example the arrangement can correspond to regularly positioned subregions 16 separated by non-diffractive regions. As used herein, the “y-axis” and the “x-axis”, and correspondingly the “y-direction” and “x-direction”, refer to orthogonal directions, preferably in the plane of the DOE 10 as shown (“y” and “x” respectively in FIG. 3). The use of specific axis and direction descriptions is for convenience in identifying the relative positioning of subregions 16 and is not to be considered limiting.

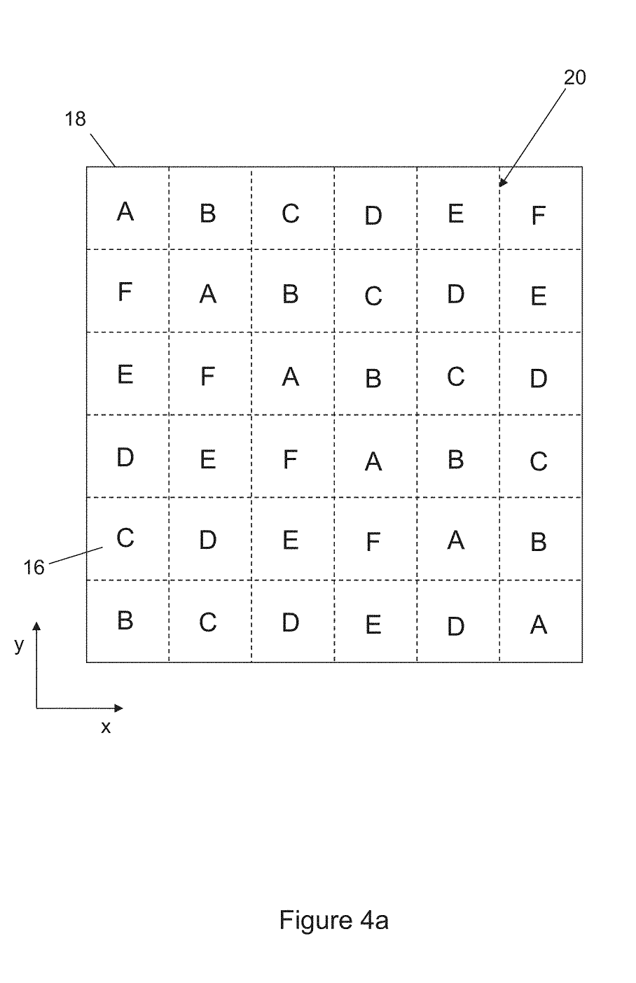

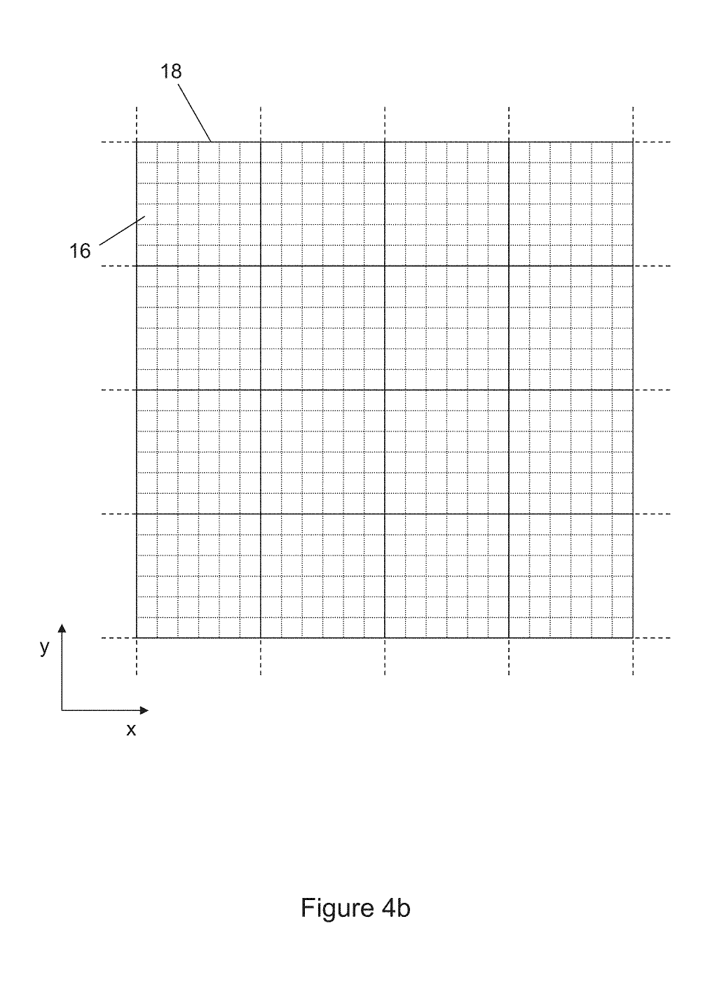

Referring to FIG. 4a, a subregion group 18 is shown including an arrangement of subregions 16. Each subregion 16 is labelled with one of: “A”, “B”, “C”, “D”, “E”, and “F”, where each letter identifies a similar subregion 16. The subregion group 18 shown in FIG. 4a can be repeated, in either one or both of the x-direction and y-direction, a plurality of times over the extent of the DOE 10, an example of which is shown in FIG. 4b, which shows sixteen subregion groups 18, each subregion group 18 including an identical arrangement of subregions 16. It should be noted that the there is no requirement for equal repetition in each direction, for example there may be no repetition of the subregion group 18 in the y-direction. According to an embodiment, apart from subregions 16 located adjacent an edge of the DOE 10, each subregion 16 is adjacent four other subregions 16.

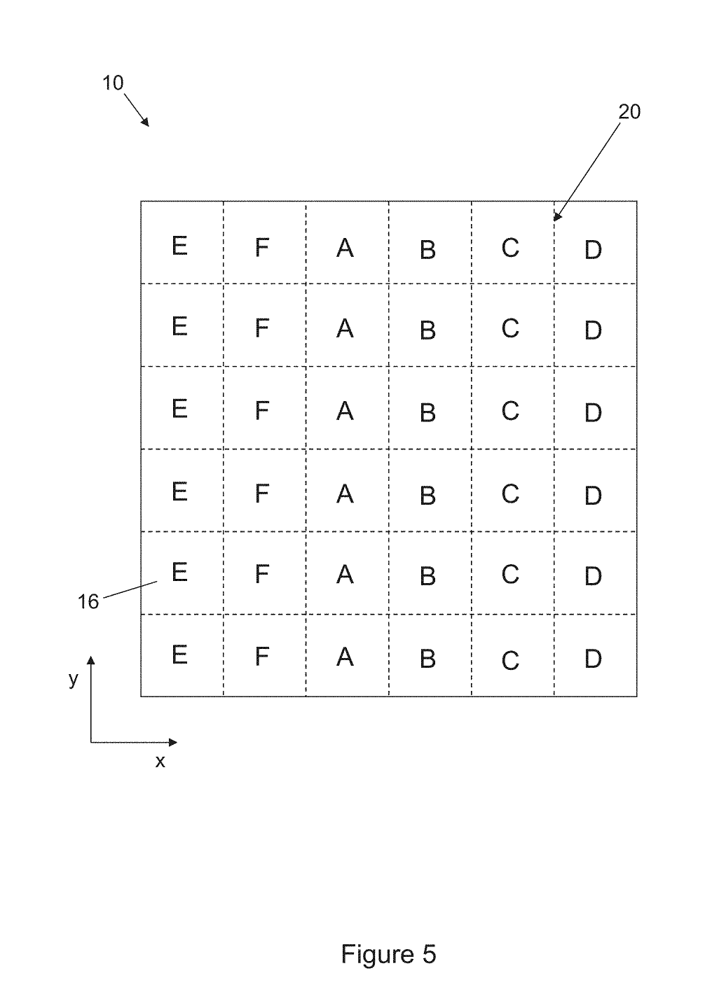

In an alternative arrangement, as shown in FIG. 5, the DOE 10 is configured to only change in appearance when the DOE 10 is moved along one axis. This can be achieved by using an alternative arrangement of subregions 16 in the subregion group 18, where each subregion 16 is adjacent similar subregions 16 along the y-axis and non-similar subregions 16 along the x-axis axis. As can be seen, each subregion 16 labelled “A” is adjacent at least one other subregion 16 labelled “A” in the y-direction and adjacent two subregions 16 labelled either “F” or “B” in the x-direction. There is, as discussed previously, no requirement for an equal number of subregions 16 along the x-axis and the y-axis. The example shown in FIG. 5 shows, for ease of illustrating differences to the arrangement of FIG. 4a, the subregion group 18 including equal numbers of subregions 16 in both the x-direction and y-direction, though it is understood this is not a requirement for the subregion group 18 for the present arrangement.

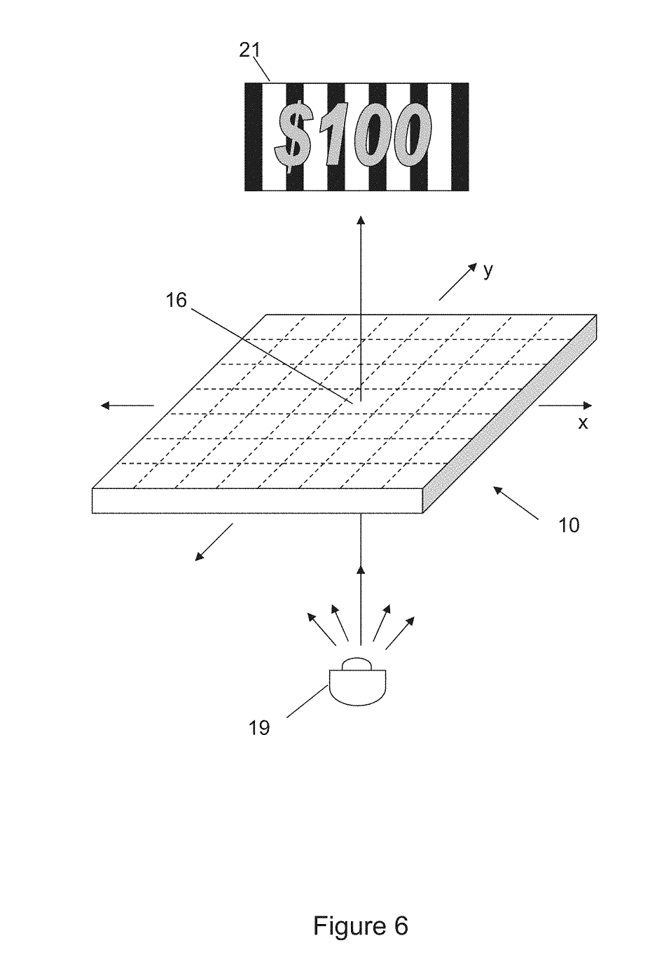

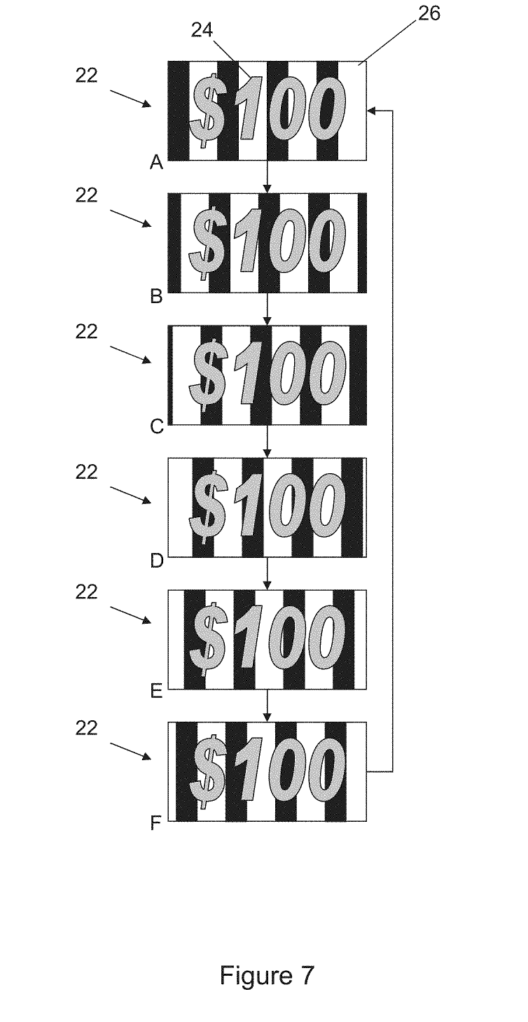

FIG. 6 shows the appearance of the DOE 10 when viewed through the individual DOE corresponding to a particular subregion 16. A point light source 19 is positioned on one side the DOE 10, and a viewer 21 is positioned on the other side, preferably directly opposite the point light source 19. Preferably, the distance between the point light source 19 and the DOE 10 is greater than the distance between the viewer 21 and the DOE 10. As each subregion 16 projects in a particular direction, only one subregion 16 is visible, or dominantly visible, for each particular configuration of viewer, DOE 10, and light source 19. Therefore, for example, as the DOE 10 is moved in either the x-direction or y-direction, a change in appearance of the DOE 10 can occur. Movement in at least one of the x-direction and y-direction is configured to display a change in appearance due to the change in particular subregion 16 (and therefore the individual DOE) being viewed, the change in appearance corresponding to an animation.

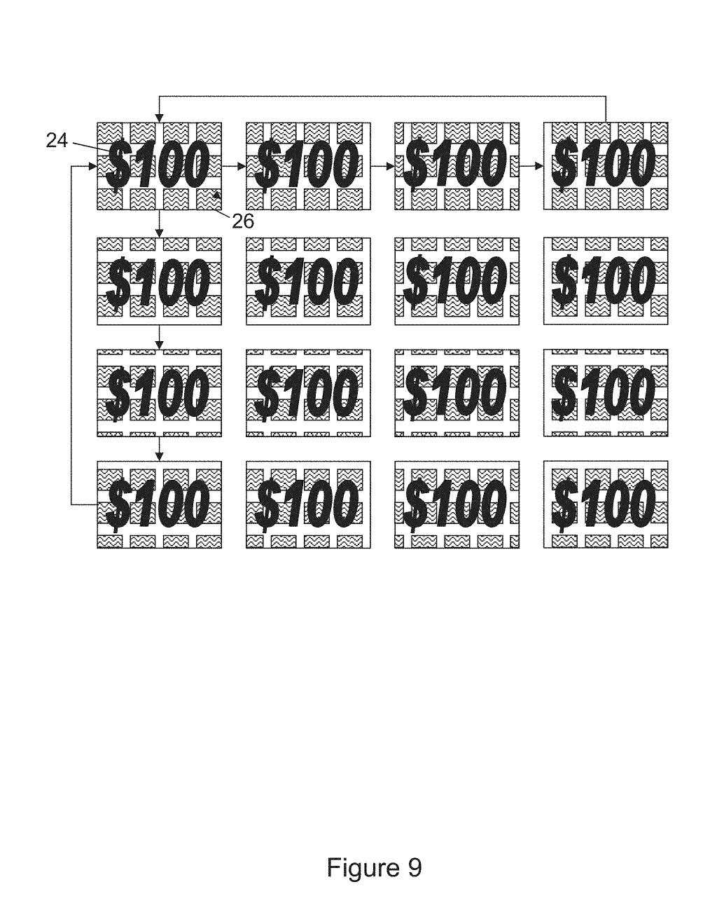

With reference to the examples of FIGS. 7 and 9, the animation is configured to include a static component 24 and a variable 26 component. The static component 24 corresponds to an image that appears unchanged as the DOE 10 is moved as described previously. The variable component 26 corresponds to an image (for example, a pattern) which appears to move or change as the DOE 10 is moved. In an embodiment, the static component 24 is configured as a foreground image and the variable component 26 is configured as a background to the foreground image. A particular implementation of this embodiment has the variable component 26 configured to seamlessly repeat each time a new subregion group 18 is encountered. In the examples shown, the variable component 26 corresponds to a moving repeating pattern.

Referring to FIG. 7, an example of the change in DOE 10 appearance due to a subregion group 18 according to FIG. 4a is shown. When the DOE 10 of FIG. 4a is moved to the right along the x-axis, or alternatively, upwards along the y-axis, for example from an “A” subregion 16 to a “B” subregion 16, the appearance of the DOE 10 changes. As shown, the appearance of the DOE 10 appears to change as each new subregion 16 is displayed, through six “animation frames” (frames 22) before repeating. In the example, the background stripes correspond to the variable component 26 and the foreground “$100” corresponds to the static component 24. As can be seen, when the progression is from A to F, the stripes appear to move from right to left. When the DOE 10 is moved in an opposite direction, the appearance of the DOE 10 changes in an opposite manner (the stripes appear to move from the left to the right). When the subregions 16 are arranged according to FIG. 5, the animation only occurs when the DOE 10 is moved in the x-direction, and not the y-direction.

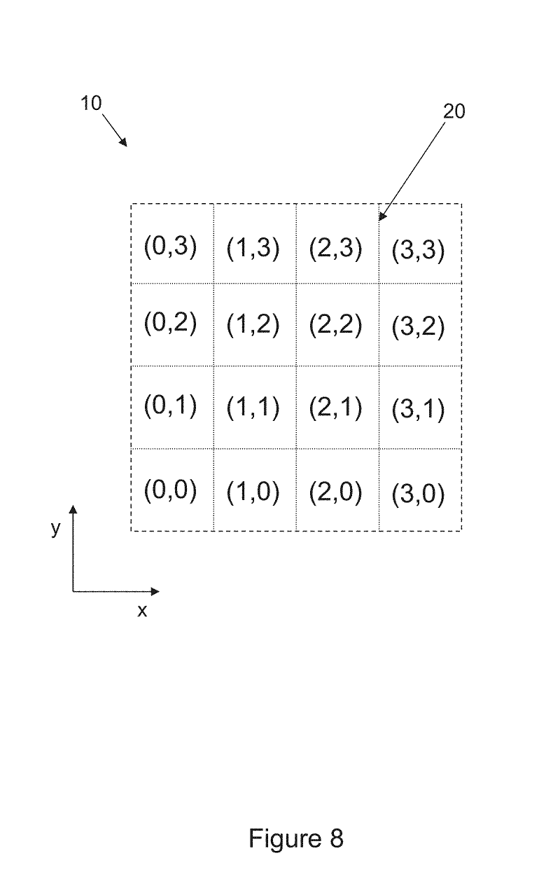

Referring to FIG. 8, another arrangement of subregions 16 of a subregion group 18 is shown. In this configuration, movement along the y-axis of the DOE 10 causes the variable component 24 to change in a different manner compared to movement along the x-axis. In the figure, the subregion group 18 shown includes sixteen subregions 16, wherein for convenience each subregion 16 is identified by two numbers corresponding to the relative position of each subregion 16 with respect to the other subregions 16 within the subregion group 18. The subregion group 18 can be repeated a plurality of times in one or each of the x-direction and y-direction. Preferably each subregion group 18 is complete (each arrangement includes the same number of subregions 16); however a subregion group 18 may be incomplete at an edge of the DOE 10.

FIG. 9 shows corresponding DOE 10 appearance associated with each subregion 16. As can be seen, the variable component 26, corresponding to the pattern of squares, appears to move as the DOE 10 is moved, whereas the foreground component, corresponding to the image of “$100”, appears to stay in the same position, and does not change in appearance. As can be seen, movement along the x-axis results in a different effect to movement along the y-axis, in this case the pattern corresponding to the variable component 26 appears to move from right to left as the DOE 10 is moved to the right along the x-axis, and from up to down as the DOE 10 is moved up along the y-axis.

The required structure for each subregion 16 (and therefore each associated DOE) within a subregion group 18 can be determined by first identifying a desired static component 24 and a desired variable component 26. The number of frames 22 is then determined, and can be selected to provide a compromise between clarity of the diffractive optical effect (larger DOEs will result in a clearer diffractive optical effect when compared to smaller DOEs) and fluidity of the animation. Such compromise can be determined experimentally and/or through simulation or calculation. The appearance of each frame 22 is then determined by combining the required appearance of the variable component 26 for the frame 22, and combining this with the static component 24. The individual DOE structure for each subregion 16 of the subregion group 18 can then be determined using known methods. Once the structure of each subregion 16 of the subregion group 18 is determined, the required structure of the DOE 10 can be determined based on an appropriate repetition of the subregion group 18. The DOE 10 can then be formed based on the determined structure using known methods.

Further modifications and improvements may be made without departing from the scope of the present invention. For example, the variable component may be a repeating structure which is different to a linear translation of a pattern, for example the variable component may be an image which appears to expand and contract.

1. An optical device, preferably a security device for a security document, including a diffractive optical element (DOE) including a plurality of subregions, wherein each subregion is configured to produce a projected image corresponding to a frame of an animation, wherein the animation includes both a static component and a variable component, and wherein the sub-regions are arranged such that when the DOE is illuminated by a point light source and moved in at least one direction, the animation is viewable as a projected image.

2. An optical device as claimed in claim 1, wherein the plurality of subregions are arranged such that when the DOE is moved in at least one direction, the animation is viewable.

3. An optical device as claimed in claim 2, wherein the arrangement of sub-regions is such that the animation is viewable when the DOE is moved in either of two orthogonal directions.

4. An optical device as claimed in claim 3, wherein the animation appears the same when the DOE is moved in either of the orthogonal directions.

5. An optical device as claimed in claim 3, wherein the animation appears different when the DOE is moved in each of the orthogonal directions.

6. An optical device as claimed in claim 2, wherein the animation is viewable when the DOE is moved in a first direction, and wherein the animation is not viewable when the DOE is moved in a second direction orthogonal to the first direction.

7. An optical device as claimed in claim 3, wherein at least one of the orthogonal directions is parallel to an edge of the DOE.

8. An optical device as claimed in claim 1, wherein the plurality of subregions are arranged into a plurality of subregion groups.

9. An optical device as claimed in claim 8, wherein at least one of the subregion groups is repeated a plurality of times in at least one direction.

10. An optical device as claimed in claim 8, wherein at least one of the subregion groups is repeated a plurality of times in a first direction and a plurality of times in a second direction, wherein the first direction is orthogonal to the second direction.

11. An optical device as claimed in claim 10, wherein each edge of each subregion group is adjacent either an edge of another subregion group or an edge of the DOE.

12. An optical device as claimed in claim 1, wherein the variable component is configured to correspond to a foreground image of the animation, and wherein the static component is configured to correspond to a background of the animation.

13. An optical device as claimed in claim 1, wherein the variable component is configured to correspond to a background of the animation, and wherein the static component is configured to correspond to a foreground image of the animation.

14. An optical device as claimed in claim 1, wherein each subregion is configured to project a DOE image in substantially the same direction.

15. An optical device as claimed in claim 1, including a substrate, wherein the DOE is formed from a radiation curable ink applied to the surface of the substrate, and wherein the DOE is formed by embossing the radiation curable ink and simultaneously or subsequently curing the radiation curable ink.

16. An optical device as claimed in claim 1, wherein the DOE is configured for viewing in one of a reflection mode or a transmission mode.

17. An optical device according to claim 1, wherein the static component and the variable component are configured such as to provide an appearance of depth for the projected image.

18. A method for determining the configuration of the diffractive optical element of the optical device according to claim 1, including the steps of:
determining the static component of the animation;
determining the variable component of the animation;
determining the required configuration of each subregion based on the static component and the variable component for the required frame of the animation; and
determining the required arrangement of the subregions based on the required appearance of the animation.

19. A method for producing an optical device according to claim 1, including the steps of:
determining the required configuration of a plurality of subregions of a DOE structure, each subregion being configured to produce a projected image corresponding to a frame of a required animation;
determining the arrangement of the plurality of subregions required to produce the animation, wherein the configuration of each subregion of the DOE structure includes a static component and a variable component for the animation;
providing a substrate; and
embossing onto a surface of the substrate a DOE structure with the required configuration and arrangement of subregions.

20. A security document, preferably a banknote, including an optical device according to claim 1.
